(19) United States
(12) Patent Application Publication
(10) Pub. No.: US 2018/0074576 A1
(43) Pub. Date: Mar. 15, 2018

(54) PROCESSING DEVICE, PROCESSING METHOD, AND COMPUTER-READABLE STORAGE MEDIUM

(71) Applicant: CASIO COMPUTER CO., LTD., Tokyo (JP)

(72) Inventor: Shunsuke HARA, Tokyo (JP)

(73) Assignee: CASIO COMPUTER CO., LTD., Tokyo (JP)

(21) Appl. No.: 15/699,901

(22) Filed: Sep. 8, 2017

(30) Foreign Application Priority Data
Sep. 13, 2016 (JP) 2016-178292

(51) Int. Cl. G06F 3/01; G06F 3/03

(52) U.S. Cl. CPC G06F 3/011; H04N 9/31; G06F 3/0304

(57) ABSTRACT

A processing device includes a hardware processor: wherein the hardware processor configured to: detect an operation of an operation part configured to operate content displayed on a display; obtain an image in which the operation part is imaged in case that the operation has been detected; extract a feature of the operation part in the image obtained by the image obtainer; and execute predetermined processing corresponding to the operation based on the feature which has been extracted.

### BACKGROUND OF THE INVENTION

### Fields of the Invention

The present invention relates to a processing device, a processing method, and a computer readable medium.

### Related Art

Conventionally, there has been a system for providing content to a user by projecting the content on a screen. For example, JP 2011-150221 A discloses a technique of projecting content on a screen formed in a shape the outline of the content when a human sensor detects a person.

However, with the technique described in JP 2011-150221 A, the content can be output according to presence/absence of the user. However, the content can be unilaterally output with the above technique. It is difficult to execute processing according to a feature of an operation part for operating the projected content.

One aspect of the present invention is summarized as a processing device including a hardware processor: wherein the hardware processor configured to: detect an operation of an operation part configured to operate content displayed on a display; obtain an image in which the operation part is imaged in case that the operation has been detected; extract a feature of the operation part in the image obtained by the image obtainer; and execute predetermined processing corresponding to the operation based on the feature which has been extracted.

### BRIEF DESCRIPTION OF DRAWINGS

FIG. 1 is a diagram of an appearance configuration of a processing system according to an embodiment of the present invention;

FIG. 2 is a diagram of an exemplary content projected by a projection device;

FIG. 3 is a schematic diagram of a structure of the processing device according to the embodiment;

FIG. 4 is a diagram of exemplary data stored in a feature DB;

FIG. 5 is a diagram of an exemplary flowchart of order management processing according to the embodiment;

FIG. 6 is a diagram of an exemplary flowchart of registration processing according to the embodiment; and

FIG. 7 is a diagram of an exemplary flowchart of collation processing according to the embodiment.

### DETAILED DESCRIPTION

An embodiment of the present invention is described with reference to the drawings below.

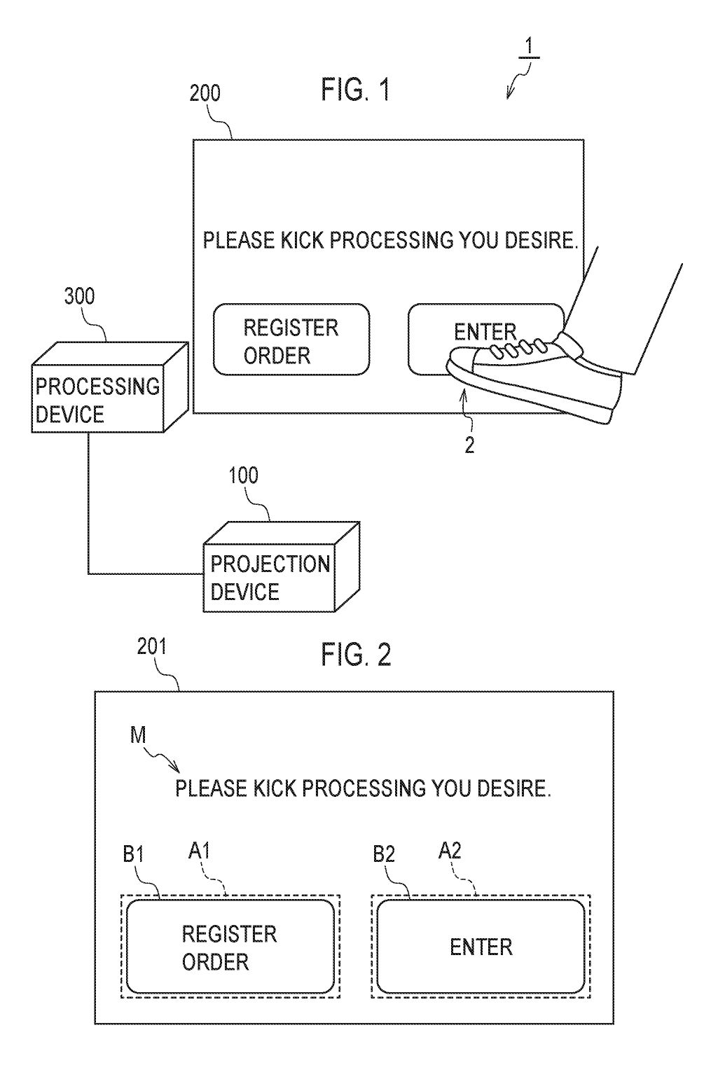

FIG. 1 is a diagram of an appearance configuration of a processing system 1 according to an embodiment of the present invention. The processing system 1 is provided in shops, public facilities, and the like and executes predetermined processing by using a digital signage (so-called electronic signboard) for displaying contents such as guidance and advertisements to a user who is a viewer.

In the present embodiment, the processing system 1 executes processing (order management processing) for managing queuing of users who enter a region to be managed as exemplary predetermined processing. For example, the order management processing includes registration processing for receiving an operation by a foot part 2 of the user and registering an order of the user and collation processing for receiving the operation by the foot part 2 of the user and collating the order of the user with a number which can make the user enter the region.

As illustrated in FIG. 1, the processing system 1 includes a projection device 100, a projection surface 200, and a processing device 300.

The projection device 100 is a device for projecting the content on the projection surface 200 and is configured of a projector that projects an image or a video. An exemplary content projected on the projection surface 200 by the projection device 100 is illustrated in FIG. 2. In the example illustrated in FIG. 2, the content is an operation receiving screen 201 for receiving an operation to select one of the registration processing and the collation processing. The operation receiving screen 201 includes buttons B1 and B2 operated by the foot part 2 of the user and a message M to urge the user to operate the buttons B1 and B2. The button B1 is an image to select the registration processing. The button B2 is an image to select the collation processing. The user selects the registration processing or the collation processing by kicking the buttons B1 and B2 projected on the projection surface 200 with the foot part 2.

The projection surface 200 is a plane on which the image or the video is projected by the projection device 100. The projection surface 200 is, for example, a wall surface of a building.

The processing device 300 is communicably connected to the projection device 100 by wire or radio and outputs the content to be projected by the projection device 100 to the projection device 100. Also, when detecting the operation by the foot part 2 of the user on the content projected on the projection surface 200, the processing device 300 executes the order management processing corresponding to the detected operation.

Next, the structure of the processing device 300 is described in detail.

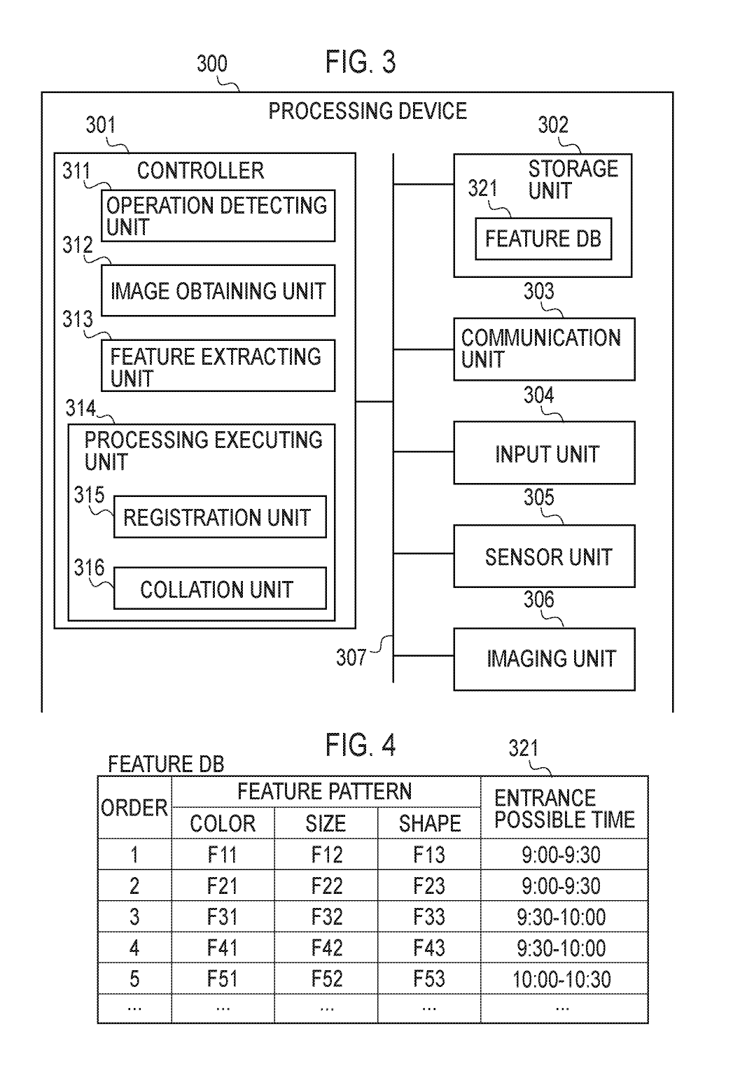

FIG. 3 is a schematic diagram of the structure of the processing device 300. As illustrated in FIG. 3, the processing device 300 includes a controller 301, a storage unit 302, a communication unit 303, an input unit 304, a sensor unit 305, and an imaging unit 306, and the units are connected via a bus 307.

The controller 301 includes a central processing unit (CPU), a read only memory (ROM), and a random access memory (RAM). The controller 301 executes a program stored in the ROM (for example, a program relating to order management processing to be described below) so as to realize functions of an operation detecting unit 311, an image obtaining unit 312, a feature extracting unit 313, and a processing executing unit 314 to be described.

The storage unit 302 is a nonvolatile memory such as a hard disk drive (HDD). The storage unit 302 stores various contents to be output to the projection device 100. Also, the storage unit 302 stores a feature database (DB) 321 to be described.

The communication unit 303 includes a communication interface to communicably connect the processing device 300 with the projection device 100.

The input unit 304 includes input devices such as a button, a keyboard, and a touch panel. The input unit 304 receives an operation input from the user of the processing device 300 and outputs a signal corresponding to the received operation input to the controller 301.

The sensor unit 305 is configured of a distance image sensor using a laser and a light receiving sensor. The sensor unit 305 is installed near a position below the projection surface 200 so that the foot part 2 of the user enters the angle of view and obtains distance image data. The distance image data includes data indicating the shape of an object to be measured, the distance to the object to be measured, and the position of the object to be measured. The sensor unit 305 outputs the obtained distance image data to the controller 301.

To obtain the distance image data as described above, the distance image data can be obtained by measuring, for example, a time until light reaches the object and returns from the object.

The imaging unit 306 is configured of an imaging device including an image sensor such as a charge coupled device (CCD) and a complementary metal oxide semiconductor (CMOS). The imaging unit 306 obtains the image including the foot part 2 of the user and outputs the image to the controller 301.

Next, the functional configuration of the controller 301 of the processing device 300 is described. As illustrated in FIG. 3, the controller 301 functions as the operation detecting unit 311, the image obtaining unit 312, the feature extracting unit 313, and the processing executing unit 314.

The operation detecting unit 311 detects the operation of the foot part 2 of the user who operates the operation receiving screen 201 displayed on the projection surface 200. For example, the operation detecting unit 311 obtains the distance image data from the sensor unit 305. Then, the operation detecting unit 311 obtains, for example, a distance between the foot part 2 of the user and the projection surface 200 in the real space from the obtained distance image data. The position of the foot part 2 of the user may be, for example, the position of the toe of the stretched foot part 2 of the user and may be the position of a part of the foot part 2 of the user closest to the projection surface 200.

Then, for example, when the distance between the foot part 2 of the user and the projection surface 200 in the real space becomes equal to or shorter than a predetermined distance, the operation detecting unit 311 detects the position of the foot part 2 of the user from the obtained distance image data. Then, when the obtained position corresponds to the positions of the buttons B1 and B2, the operation detecting unit 311 determines that the operation of the foot part 2 of the user has been detected. For example, in FIG. 2, in a case where the obtained position is positioned in a region A1, the operation detecting unit 311 determines that an operation for selecting the button B1 (registration processing) has been detected. In a case where the obtained position is positioned in a region A2, the operation detecting unit 311 determines that an operation for selecting the button B2 (collation processing) has been detected.

When the operation detecting unit 311 has detected the operation, the image obtaining unit 312 images an image of the foot part 2 of the user and obtains an image. For example, when the operation detecting unit 311 determines that the operation by the foot part 2 of the user has been detected, the image obtaining unit 312 controls the imaging unit 306 to capture an image of the foot part 2 of the user as an object and obtains the image from the imaging unit 306.

The feature extracting unit 313 extracts the feature of the foot part 2 of the user in the image obtained by the image obtaining unit 312. For example, the feature extracting unit 313 extracts the color, the size, and the shape of the foot part 2 of the user included in the image as features. For example, the foot part 2 of the user may include shoes, clothes such as trousers, skirts, and socks, and the feature extracting unit 313 may extract the colors, the sizes and the shapes of the above items as features. As a method of extracting the feature of the foot part 2 of the user from the image, a general image feature extraction technique can be used.

Based on the features extracted by the feature extracting unit 313, the processing executing unit 314 executes the order management processing corresponding to the operation detected by the operation detecting unit 311. For example, the processing executing unit 314 includes a registration unit 315 for executing the registration processing and a collation unit 316 for executing the collation processing.

When the operation detected by the operation detecting unit 311 indicates the selection of the registration processing, the registration unit 315 executes the registration processing for registering the feature extracted by the feature extracting unit 313 in the feature DB 321 as a feature pattern.

Here, data stored in the feature DB 321 is described. FIG. 4 is a diagram of exemplary data stored in the feature DB 321. As illustrated in FIG. 4, the feature DB 321 stores an order, a feature pattern, and an entrance possible time in association with each other. The order indicates an order of registration to the registration unit 315. The feature pattern is the feature extracted by the feature extracting unit 313 and includes the color, the size, and the shape of the foot part 2 of the user. The entrance possible time indicates a time when the user can enter the region to be managed. In the present embodiment, it is assumed that two users can enter the region to be managed every 30 minutes.

When the operation detected by the operation detecting unit 311 indicates the selection of the registration processing, the registration unit 315 assigns the order and the entrance possible time as using the features extracted by the feature extracting unit 313 as the feature pattern and registers the order and the entrance possible time to the feature DB 321.

When the operation detected by the operation detecting unit 311 indicates the selection of the collation processing, the collation unit 316 executes the collation processing for determining whether the feature extracted by the feature extracting unit 313 matches the feature pattern which has been previously registered to the feature DB 321. For example, in a case where the feature extracted by the feature extracting unit 313 matches the feature pattern which has been previously registered to the feature DB 321 and the current time is within the entrance possible time corresponding to the feature pattern, the collation unit 316 outputs the screen indicating the admission to the projection device 100. Also, for example, in a case where the feature extracted by the feature extracting unit 313 does not match the feature pattern which has been previously registered in the feature DB 321, or in a case where the current time is out of the entrance possible time corresponding to the matched feature pattern, the collation unit 316 outputs a screen indicating that the entrance is not available to the projection device 100. Also, in a case where the feature pattern matching the extracted feature is not registered to the feature DB 321, the collation unit 316 may output a message to urge the user to perform registration.

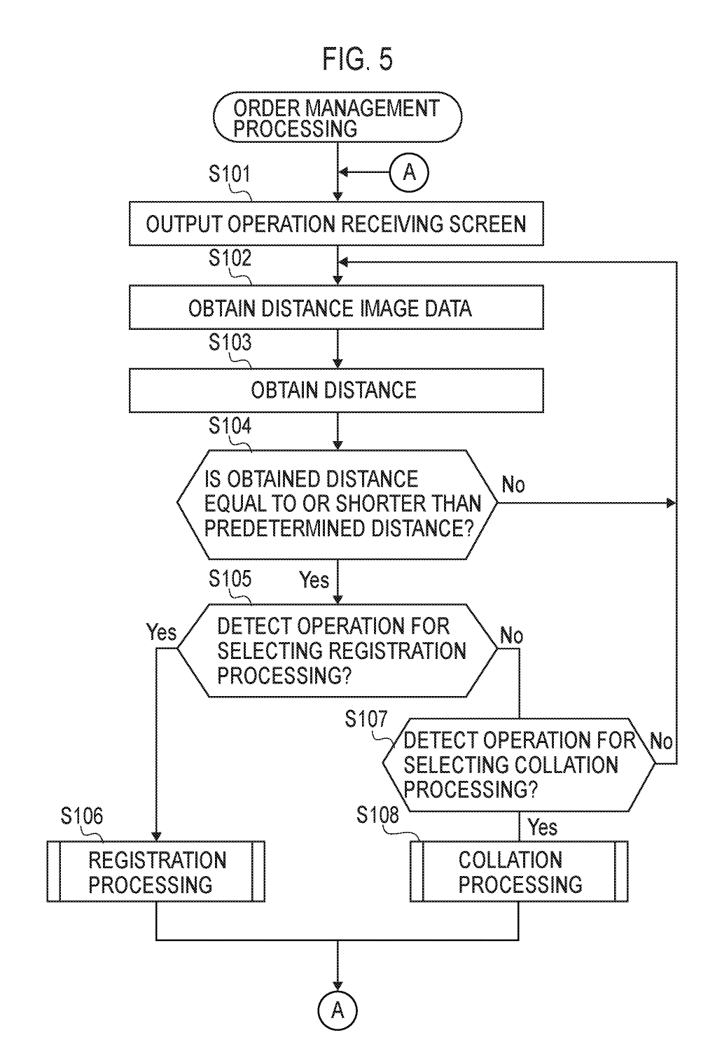

Next, the order management processing executed by the controller 301 of the processing device 300 according to the present embodiment is described. FIG. 5 is an exemplary flowchart of the order management processing according to the present embodiment. The order management processing is started, for example, upon receiving an operation to instruct the start of the present processing via the input unit 304 as a trigger.

First, the operation detecting unit 311 outputs the operation receiving screen 201 illustrated in FIG. 2 to the projection device 100 (step S101).

Next, the operation detecting unit 311 obtains the distance image data from the sensor unit 305 (step S102).

Then, the operation detecting unit 311 obtains a distance between the projection surface 200 and the foot part 2 of the user from the distance image data obtained in step S102 (step S103).

Then, the operation detecting unit 311 determines whether the distance obtained in step S103 is equal to or shorter than a predetermined distance (step S104). In a case where the operation detecting unit 311 determines that the obtained distance is not equal to or shorter than the predetermined distance (step S104; No), the procedure returns to step S102, and the operation detecting unit 311 repeats the subsequent processing.

In a case where the operation detecting unit 311 determines that the obtained distance is equal to or shorter than the predetermined distance (step S104; Yes), the operation detecting unit 311 determines whether operation for selecting the registration processing by the foot part 2 of the user is detected from the distance image data obtained in step S102 (step S105).

In a case where the operation detecting unit 311 determines that the operation for selecting the registration processing by the foot part 2 of the user has been detected (step S105; Yes), the controller 301 executes the registration processing (step S106).

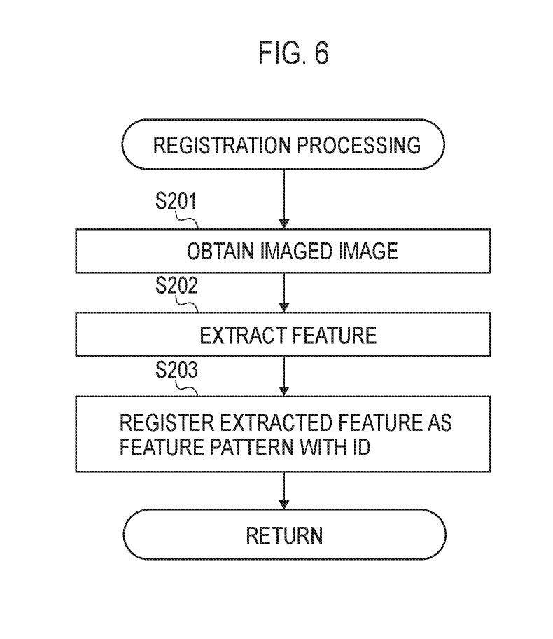

FIG. 6 is an exemplary flowchart of the registration processing according to the present embodiment. When the controller 301 starts the registration processing, the image obtaining unit 312 obtains an image including the foot part 2 of the user from the imaging unit 306 (step S201).

Next, the feature extracting unit 313 extracts the feature of the foot part 2 of the user from the image obtained in step S201 (step S202).

Then, the registration unit 315 registers the feature extracted in step S202 to the feature DB 321 as the feature pattern together with the order and the entrance possible time (step S203). Then, the procedure returns to step S101 in FIG. 5, and the controller 301 repeats the subsequent processing.

Returning to FIG. 5, in a case where the operation detecting unit 311 determines that the operation for selecting the registration processing by the foot part 2 of the user has not been detected (step S105; No), the operation detecting unit 311 determines whether an operation for selecting the collation processing by the foot part 2 of the user has been detected (step S107). In a case where the operation detecting unit 311 determines that the operation for selecting the collation processing by the foot part 2 of the user has not been detected (step S107; No), the procedure returns to step S102, and the controller 301 repeats the subsequent processing.

In a case where the operation detecting unit 311 determines that the operation for selecting the collation processing by the foot part 2 of the user has been detected (step S107; Yes), the controller 301 executes the collation processing (step S108).

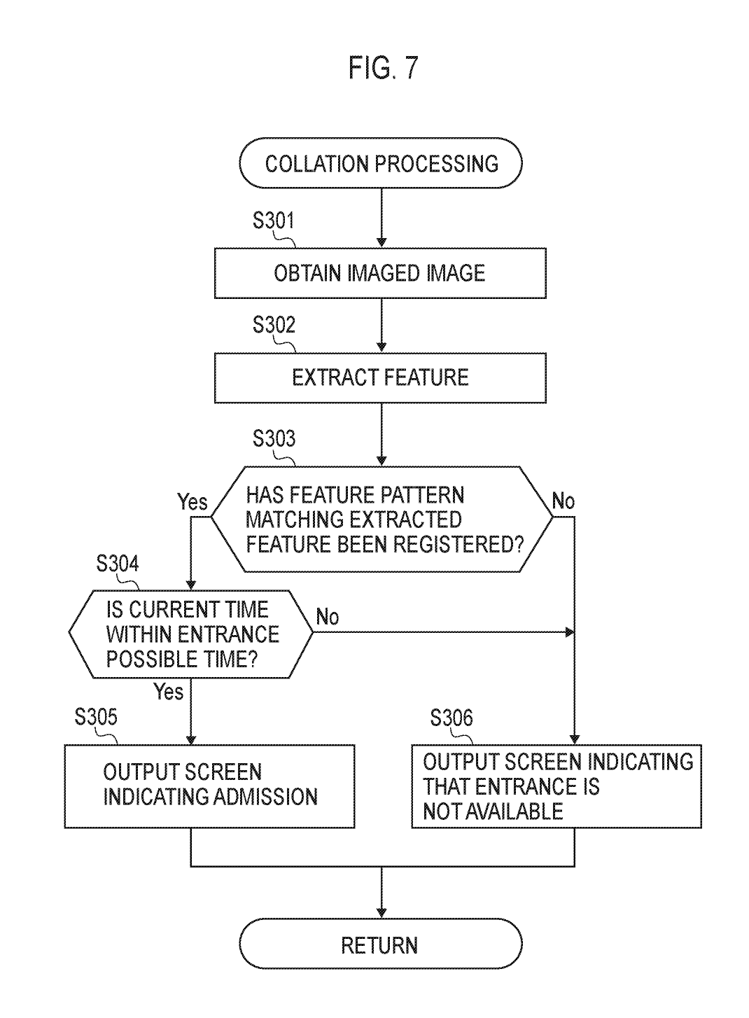

FIG. 7 is an exemplary flowchart of the collation processing according to the present embodiment. Upon starting the collation processing, the controller 301 executes the processing in steps S301 and S302 similarly to the processing in steps S201 and S202 of the registration processing illustrated in FIG. 6.

Then, the collation unit 316 determines whether the feature pattern matching the feature extracted in step S302 has been already registered in the feature DB 321 (step S303).

In a case where the collation unit 316 determines that the feature pattern matching the feature extracted instep S302 has been registered in the feature DB 321 (step S303; Yes), the collation unit 316 determines whether the current time is within the entrance possible time corresponding to the feature pattern (step S304).

In a case where the collation unit 316 determines that the current time is within the entrance possible time (step S304; Yes), the collation unit 316 outputs a screen indicating admission to the projection device 100 (step S305). Then, the procedure returns to step S101 in FIG. 5, and the controller 301 repeats the subsequent processing.

In a case where the collation unit 316 determines that the feature pattern matching the feature extracted instep S302 has not been registered in the feature DB 321 (step S303; No), or in a case where the collation unit 316 determines that the current time is not within the entrance possible time (step S304; No), the collation unit 316 outputs a screen indicating that the entrance is not available to the projection device 100 (step S306). Then, the procedure returns to step S101 in FIG. 5, and the controller 301 repeats the subsequent processing.

The above processing is repeatedly executed, for example, until the power supply of the processing device 300 is turned off or an operation input indicating the end of the output processing is received from the user via the input unit 304.

As described above, when detecting the operation by the foot part 2 of the user on the projection surface 200 where the content is displayed, the processing device 300 according to the present embodiment images an image of the foot part 2 of the user. Then, the processing device 300 extracts the feature of the foot part 2 of the user from the image and executes the order management processing corresponding to the detected operation based on the extracted feature. Therefore, the processing device 300 can execute the processing according to the feature of the foot part 2 of the user.

Also, the processing device 300 detects the operation by the foot part 2 of the user to the content projected on the wall surface as the projection surface 200. Therefore, even the user who has difficulty in performing an operation with hands, for example, a user having baggage in both hands, can easily operate the content. Also, since the content is projected on the wall surface, unlike a display device such as a liquid crystal panel, the content is hardly damaged even when the user kicks the content.

Also, since the processing device 300 uses the feature of the foot part 2 of the user for authentication of the user in the order management processing, it is possible to reduce the labor and cost required for an issuance of tickets and manual order management.

The description of the embodiment is completed. However, the embodiment is one example. The specific structure of the processing device 300 and the content of the output control processing are not limited to those described above, and the following modification can be applied.

For example, in the above embodiment, an example has been described in which the processing device 300 detects the operation by the foot part 2 of the user. However, the operation detected by the processing device 300 is not limited to the operation by the foot part 2 of the user. That is, the operation part according to the present invention is not limited to the foot part 2 of the user and may be, for example, a hand of the user.

Also, in the above embodiment, an example has been described in which the projection surface 200 is the wall surface. However, the projection surface 200 may be a floor surface.

Also, in the above embodiment, an example has been described in which the projection device 100 projects the content on the projection surface 200. However, the method for displaying the content on the display according to the present invention is not limited to this. For example, the content may be displayed on the display of the display device such as a liquid crystal display (LCD) and an electroluminescence (EL) display.

Also, in the above embodiment, the operation detecting unit 311 detects the operation by the foot part 2 of the user based on the distance image data obtained from the sensor unit 305. However, the method for detecting the operation is not limited to this. For example, the sensor unit 305 of the processing device 300 may include a vibration sensor for detecting vibration of the projection surface 200. In this case, the operation detecting unit 311 obtains vibration data indicating the vibration of the projection surface 200 from the vibration sensor. Then, for example, when the distance obtained from the distance image data is zero and an amplitude indicated by the vibration data is larger than a predetermined threshold value, the operation detecting unit 311 determines that the foot part 2 of the user touches the projection surface. As a result, the processing device 300 can more accurately detect the contact of the foot part 2 of the user with the projection surface 200.

Also, in the above embodiment, the feature extracting unit 313 extracts the color, the size, and the shape of the foot part 2 of the user as features. However, the features extracted by the feature extracting unit 313 are not limited to these and may be at least one of them.

Also, in the above embodiment, an example has been described in which the collation unit 316 determines whether the feature pattern registered by the registration unit 315 matches the feature extracted by the feature extracting unit 313. However, the collation unit 316 may determine whether the predetermined feature pattern previously recorded in the storage unit 302, not the feature pattern registered by the registration unit 315, matches the feature extracted by the feature extracting unit 313.

In the above embodiment, the processing device 300 executes the order management processing for managing the order. However, the predetermined processing executed by the processing device 300 is not limited to this, and the processing device can execute various processing. For example, the processing device 300 may be used for registration of a user who has paid the fee and confirmation of payment in charge adjustment in public transportation.

Also, the processing device 300 according to the present invention can be realized by using a normal computer, not a dedicated device. For example, the processing device 300 may be realized by executing a program by a computer. The program to realize the function of the processing device 300 may be stored in a computer-readable recording medium such as a universal serial bus (USB) memory, a compact disc read only memory (CD-ROM), a digital versatile disc (DVD), and an HDD or may be downloaded to the computer via a network.

Although the preferred embodiment of the present invention has been described above. However, the present invention is not limited to the specific embodiment, and the present invention includes the inventions described in the claims and the equivalent scope thereof. The invention described in the original claims of the present application is added below.

What is claimed is:

1. A processing device comprising a hardware processor:
wherein the hardware processor configured to:
detect an operation of an operation part configured to operate content displayed on a display;
obtain an image in which the operation part is imaged in case that the operation has been detected;
extract a feature of the operation part in the image obtained by the image obtainer; and
execute predetermined processing corresponding to the operation based on the feature which has been extracted.

2. The processing device according to claim 1, wherein the hardware processor configured to:
execute collation processing for determining whether or not the feature extracted by the feature extractor matches a feature pattern which has been previously registered in a storage as the predetermined processing.

3. The processing device according to claim 2, wherein the hardware processor configured to:
execute registration processing for registering the feature to the storage as the feature pattern, as the predetermined processing.

4. The processing device according to claim 1, wherein the hardware processor configured to:
detect an operation to the content projected on a wall surface or a floor surface by a foot part of a user as the operation part.

5. The processing device according to claim 1, wherein the hardware processor configured to:
obtain a distance between the operation part and the display, and detect an operation by the operation part based on the obtained distance.

6. The processing device according to claim 5, wherein the hardware processor configured to:
obtain vibration data indicating vibration of the display, and detect the operation by the operation part based on the obtained vibration data and the obtained distance.

7. The processing device according to claim 1, wherein the hardware processor configured to:
extract at least one of a color, a size, and a shape of the operation part as the feature.

8. The processing device according to claim 3, wherein the hardware processor configured to:
extract at least one of a color, a size, and a shape of the operation part as the feature.

9. The processing device according to claim 6, wherein the hardware processor configured to:
extract at least one of a color, a size, and a shape of the operation part as the feature.

10. The processing device according to claim 1, wherein
the image obtainer further includes an imaging unit, and
when the operation detector detects the operation, the image obtainer is configured to obtain the image by imaging the operation part by the imaging unit.

11. A processing method comprising:
detect an operation of an operation part configured to operate content displayed on a display;
obtain an image in which the operation part is imaged in case that the operation has been detected;
extract a feature of the operation part in the image obtained by the image obtainer; and
execute predetermined processing corresponding to the operation based on the feature which has been extracted.

12. A non-transitory storage medium encoded with a computer-readable program that enables a computer to execute functions as:
detect an operation of an operation part configured to operate content displayed on a display;
obtain an image in which the operation part is imaged in case that the operation has been detected;
extract a feature of the operation part in the image obtained by the image obtainer; and
execute predetermined processing corresponding to the operation based on the feature which has been extracted.
